(19) United States
(12) Patent Application Publication
(10) Pub. No.: US 2018/0303209 A1
(43) Pub. Date: Oct. 25, 2018

(54) Glowing Rosary

(71) Applicant: Sylvana McGraw, Los Angeles, CA (US)

(72) Inventor: Sylvana McGraw, Los Angeles, CA (US)

(21) Appl. No.: 15/961,083

(22) Filed: Apr. 24, 2018

Related U.S. Application Data
(60) Provisional application No. 62/489,742, filed on Apr. 25, 2017.

(51) Int. Cl. A44C 23/00; F21V 33/00

(52) U.S. Cl. CPC A44C 23/00; F21Y 2115/10; F21V 33/0004

(57) ABSTRACT

A rosary designed to provide light to the user engaged in prayer, eliminating the need for the use of candles or phosphorescent rosaries in vigils and dimly lit churches. The Rosary is composed of a plurality of beads encompassed around LED enabled wire attached to a printed circuit board located in the Rosary's medallion. Also attached to the Printed Circuit Board is an LED enabled crucifix. The Printed Circuit Board is LED enabled as well, and contains a power switch that provides all parts of the Rosary with power from the Rosary's battery, also contained in the medallion. The Rosary provides a source of light to users and is designed to withstand outdoor climate conditions such as wind and rain, providing an additional benefit over the use of candles in prayer.

### BACKGROUND OF THE INVENTION

For centuries, rosaries have guided Catholics through the recitation of a formal sequence of prayers. Traditionally, the user interweaves the rosary through their fingers as she clasps her hands together in the customary prayer position. The devout Catholic, however, participates in a variety of vigils that occur in dimly-lit Churches or outside under the shroud of night. Currently, prayer leaders distribute candles at these congregations so as to provide individual sources of light. However, utilizing these candles requires the user to unclasp their hands, avoid the candle's flame, and dispose of melted wax, all of which ultimately distracts the user from their prayers.

Some congregations attempt to solve this problem by utilizing plastic rosaries made of phosphorescent material. However, while the phosphorescent material enables the user to view the rosary, it fails to offer sufficient lighting to brighten the user's environment. Furthermore, while U.S. Pat. No. 7,204,694 to Delvecchio, et al. provides for a visual indicator, said indicator provides a means for users to track their prayers rather than provide a source of light. U.S. Pat. No. 2,759,096 to Caissie provides for an illuminated rosary, but the rosary's size and methods of construction make it suited for “outdoor display on a shrine or building”, rather than use in daily prayer.

Accordingly, the need for a light-producing rosary suited for everyday use has yet to be addressed.

### BRIEF SUMMARY OF THE INVENTION

In view of the foregoing background, it is therefore an object of the present invention to provide a rosary that readily provides the user with a source of light. This, and other advantages of the present invention, are accomplished by enclosing a plurality of transparent acrylic beads and a plastic crucifix around interconnected LED wires. Each end of the wire is soldered to a printed circuit board located in the Rosary's medallion, which also contains a CR-2016 Battery Cell, LEDs, and a power switch. The medallion, in turn, is connected to an additional LED wire leading to the Plastic Crucifix, thereby creating an electrical circuit leading from the medallion to the LEDs located on both the Crucifix and the necklace portions of the Rosary.

The present invention addresses the current need of readily available light throughout vigils and other prayers without the need to resort to using a candle and the various distractions that entails. The Rosary is made with durable materials designed to withstand outdoor weather conditions, thus allowing users to pray in the wind and rain, addressing a severe drawback of using a candle. With it's warm glow, the Rosary is a spiritual companion to all, even in the comfort of their own homes. Furthermore, as religious accessories have become more widely sought after, the present invention offers users the unique ability to proudly and prominently display their faith on their persons, their cars, and their homes. Features, objects and advantages of the present invention will become apparent from the following more detailed description of the invention, in conjunction with the accompanying drawings, which illustrate, by way of example, the present invention.

### BRIEF DESCRIPTION OF THE DRAWINGS

FIG. 1. Is a front elevational schematic of an LED enabled rosary, illustrating the plurality of beads, the power switch medallion, and the crucifix.

FIG. 2. Is an exploded view depicting the assembly of the Rosary's medallion, crucifix, and LED-enabled beads.

### DETAILED DESCRIPTION OF THE INVENTION

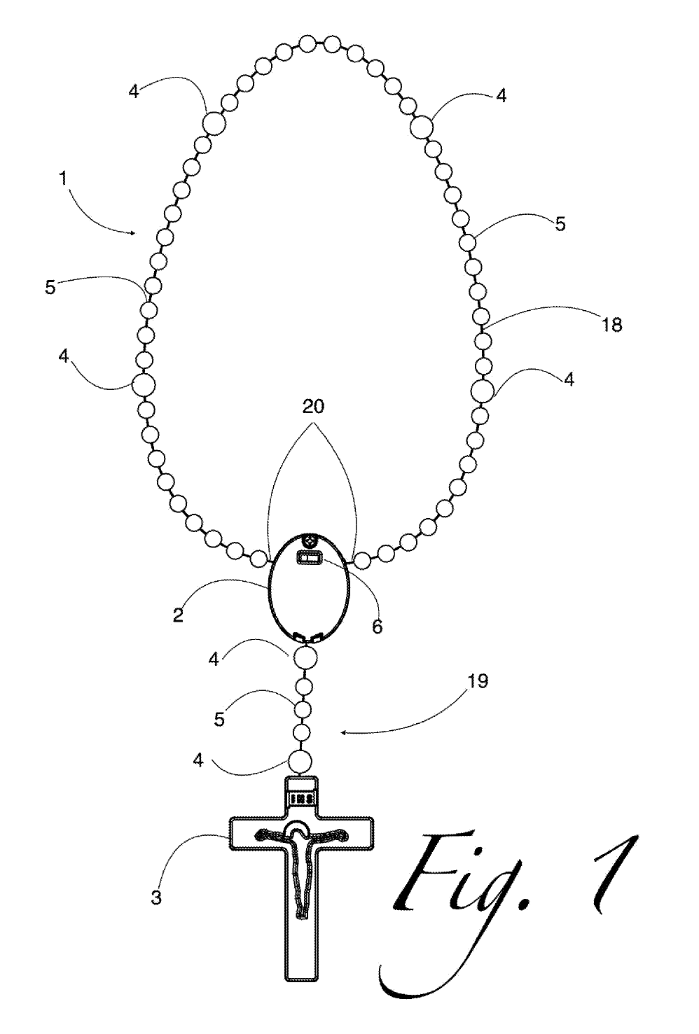

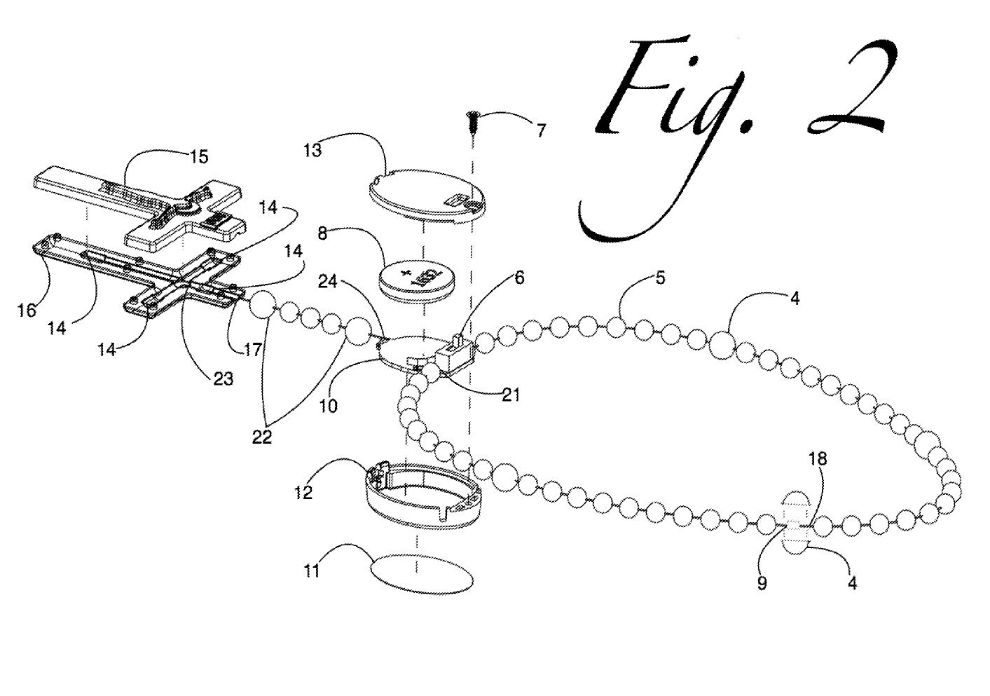

The present invention will hereinafter be described with more detail in reference to the various accompanying drawings. FIG. 1 illustrates the LED enabled rosary as a whole and in elevational view, while FIG. 2 displays the various components and assembly necessary to construct the Rosary's medallion 2, crucifix 3, and LED enabled Beads 4. The necklace portion of the Rosary 1 is constructed by first attaching 4 0603 Chip LED lights 9 to a pair of 449 mm length wire 18. A plurality of 8 mm Transparent Acrylic Beads 5 and 10 mm Transparent Acrylic Beads 4 are then strung over the 449 mm wire 18. The first 10 mm Bead 4 is centered over a Chip LED 9 and secured with plastic bonding material cured using UV Light. 10 8 mm Beads 5 are then slid onto the wire and positioned next to the previous installed 10 mm Bead 4, followed by an additional 10 mm Bead 4. The process is repeated until all LEDs 9 are enclosed by 10 mm Beads 4, and the necklace portion of the rosary 1 is composed of 4 10 mm beads 5 (enclosed around LED Chips) and 50 8 mm Beads 5. Both ends of the wire 18 are then fitted with 6 mm segment of heat shrink tubing 20.

The crucifix portion of the Rosary 19 is constructed by first attaching 6 0603 Chip LED lights 14, 22 to a 108 mm and 23 mm cross Wire 23. The Wire 23 is then placed into a plastic crucifix base 16, with the LED lights 14 faced up. UV plastic bond is then applied to ensure the LED wire 23 is held in place. Heat shrink tubing 17 is then attached to the top of the crucifix. The cross assembly is completed by attaching the plastic crucifix cover 15 to the base 16, leaving a portion of the wire 23 containing two LED lights 22 exposed. A 10 mm Frosted Bead 4 is then strung over the wire and secured over the LED 22 with a UV plastic bond, followed by three 8 mm Frosted Beads 5, an additional 10 mm Frosted bead which is also secured over the LED 22 with a UV plastic bond, and 5 mm of heat shrink tubing. The crucifix portion of the Rosary 19 is now complete, comprised of a crucifix enclosed around 4 LEDs 3, three 8 mm Frosted Beads 5, and two 2 mm LED-enabled Frosted Beads 4, 22.

The Medallion 2 is constructed by soldering the heat shrink tubing ends 24, 21 of the 449 mm wire 18 and the 108 mm Wire 23 to the Printed Circuit Board 10, according to the polarity of the respective pair of wires. The Printed Circuit Board 10 creates an electrical circuit, controlled by the Printed Circuit Board's power switch 6, that illuminates the LED enabled Beads 4, 22 on both the Necklace portion 1, Medallion 2, and Crucifix portion 19 of the Rosary, allowing the user to easily and instantly activate the Rosary's lighting. The Printed Circuit Board 10, now soldered onto both wire ends 17, 21, is then placed into the Medallion Housing Base 12. A CR2016 Coin Batter 8 is fitted into the Medallion Housing Base 12 atop the Printed Circuit Board 10, providing power to the Rosary as a whole. The Medallion Housing Cover 13 is then placed on top of the Housing Base 12, and secured with a #0-3/16 Phillips Flat SS Screw 7. A sticker 11 displaying the image of the Virgin Mary, or a variety of other Religious figures, is then affixed onto the Medallion, thus completing the Rosary's assembly.

The aforementioned process of construction enables an LED enabled rosary suitable for daily use in prayer to be constructed on a cost-effective basis. In the alternative, the Rosary can be constructed in an identical manner, but without the use of LED enabled beads 4 on the necklace portion of the Rosary 1. While the resulting rosary provides less light to the user, it is nevertheless an improvement upon the current solutions available to the devout Catholic, and can be constructed and distributed at a reduced cost when compared to the fully LED-enabled rosary described above.

The LED enabled rosary provides the user with a source of light and protects this source of light from weather conditions common to outdoor processions, such as wind and rain. In addition, the rosary can be worn as an accessory on one's person, or attached to one's vehicle or property as a prominent display of one's faith. Previous inventions in this field have focused on providing users with a tool to memorize the procession of prayers in the Rosary, U.S. Pat. No. 7,204,694 to Delvecchio, or an illuminated rosary suitable for outdoor display, U.S. Pat. No. 2,759,096 to Caissie, rather than providing for a rosary that illuminates the user's surroundings and provides for an accessory suitable for display on one's person.

The claimed invention is:

1. A rosary for providing light to users during prayers comprising:
a. A necklace containing a plurality of beads encompassed around Light-Emitting Diodes;
b. A plurality of beads connected to a crucifix containing Light-Emitting Diodes;
c. A Medallion containing additional Light-Emitting Diodes, a circuit board with a power switch, and a battery.

2. A rosary identical to that described in claim 1 wherein the necklace beads described under (a) do not contain Light-Emitting Diodes.
